(19) United States
(12) Patent Application Publication
(10) Pub. No.: US 2010/0008744 A1
(43) Pub. Date: Jan. 14, 2010

(54) Board member mounting structure

(76) Inventors: Chen-Chi Tseng, Taichung County (TW); Hsien-Jui Yu, Chang Hua Hsien (TW)

Correspondence Address: BACON & THOMAS, PLLC, 625 SLATERS LANE, FOURTH FLOOR, ALEXANDRIA, VA, 22314-1176, US

(21) Appl. No.: 12/222,817

(22) Filed: Aug. 18, 2008

(30) Foreign Application Priority Data
Jul. 10, 2008 (TW) 97212286

(51) Int. Cl. F16B 39/00

(52) U.S. Cl. 411/166

(57) ABSTRACT

A board member mounting structure includes a first board member having a number of recessed portions and an opening in each recessed portion, a second board member attached to the first board member at right angles and having locating notches corresponding to the openings in the recessed portions of the first board member, first fastening members each having a flat head fitted into one recessed portion of the first board member and a shoulder extended from the flat head and fitted into the opening in one recessed portion of the first board member and a bolt downwardly extending from the shoulder to the outside of the first board member, second fastening members respectively mounting in the locating notches of the second board member, each second fastening member having a mounting hole that receives the bolt of one first fastening member and a side hole perpendicularly extending from the bottom side of the mounting hole to the outside of the respective second fastening member, and connectors respectively inserted into the side hole of each second fastening member and respectively detachably fastened to the bolt of each first fastening member.

### BACKGROUND OF THE INVENTION

1. Field of the Invention

The present invention relates to board member mounting technology and more particularly, to a board member mounting structure, which allows quick mounting and dismounting of board members, more particularly, soft board members.

2. Description of the Related Art

Combination storage/display racks are commonly used in sales centers and shopping malls. These combination storage/display racks are commonly made by: driving mounting screws through vertical side plate members into respective screw holes at the distal ends of horizontal plate members to affix the vertical side plat members and the horizontal plate members together. A combination storage/display rack of this design can only use hard wooden plate members or metal plate members that have a high strength.

Soft board members (for example, paper board members) are not applicable for the construction of a combination storage/display racks with screws. When driving a screw into a soft board member, the structural strength of the soft board member will be obstructed. When a combination storage/display rack constructed in this way carries a heavy load, the connection area around each mounting screw may break, causing the rack to collapse. Therefore, few people utilize paper board members to construct a combination storage/display rack.

### SUMMARY OF THE INVENTION

The present invention has been accomplished under the circumstances in view. It is therefore the main object of the present invention to provide a board member mounting structure, which utilizes soft board members for constructing a combination cabinet or the like, facilitating mounting and dismounting of the combination structure.

To achieve this and other objects of the present invention, the board member mounting structure comprises a first board member, the first board member comprising at least one recessed portion and an opening in each recessed portion; at least one first fastening members respectively mounted in the at least one recessed portion of the first board member, each first fastening member comprising a flat head attached to one recessed portion of the first board member, a shoulder extended from a bottom side of the flat head and inserted into the opening in the associating recessed portion of the first board member, and a bolt downwardly extending from a bottom side of the shoulder and extending out of the first board member; a second board member, the second board member comprising at least one locating notch at one border edge thereof, each locating notch having a relatively wider bottom side and a relatively narrower top side; at least one second fastening members respectively mounting in the at least one locating notch of the second board member, each second fastening member having a shape fitting the shape of the at least one locating notch, each second fastening member having a mounting hole axially extending to one end thereof corresponding to an outer opening of each locating notch and a side hole perpendicularly extending from a bottom side of the mounting hole to one side of the respective second fastening member; and at least one connector respectively inserted into the side hole of each second fastening member and respectively detachably fastened to the bolt of each first fastening member. After installation of the at least one first fastening member in the first board member and the at least one second fastening member in the second board member, the first board member 11 is attached to one border edge of the second board member to force the bolt of each first fastening member into the mounting hole of the associating second fastening member, and then the at least one connector is respectively inserted into the side hole of each of the at least one second fastening member and rotated to fasten up the at least one connector and the at least one first fastening member, and therefore the first board member and the second board member are firmly fastened together.

### BRIEF DESCRIPTION OF THE DRAWING

FIG. 1 is an exploded view of a part of a board member mounting structure in accordance with the present invention.

FIG. 2 is an exploded, oblique bottom view of the board member mounting structure in accordance with the present invention.

FIG. 3 is a schematic drawing showing an application example of the present invention.

FIG. 4 corresponds to FIG. 3 when viewed upwards from another angle.

FIG. 5 corresponds to FIG. 3, showing the structure assembled.

### DETAILED DESCRIPTION OF THE INVENTION

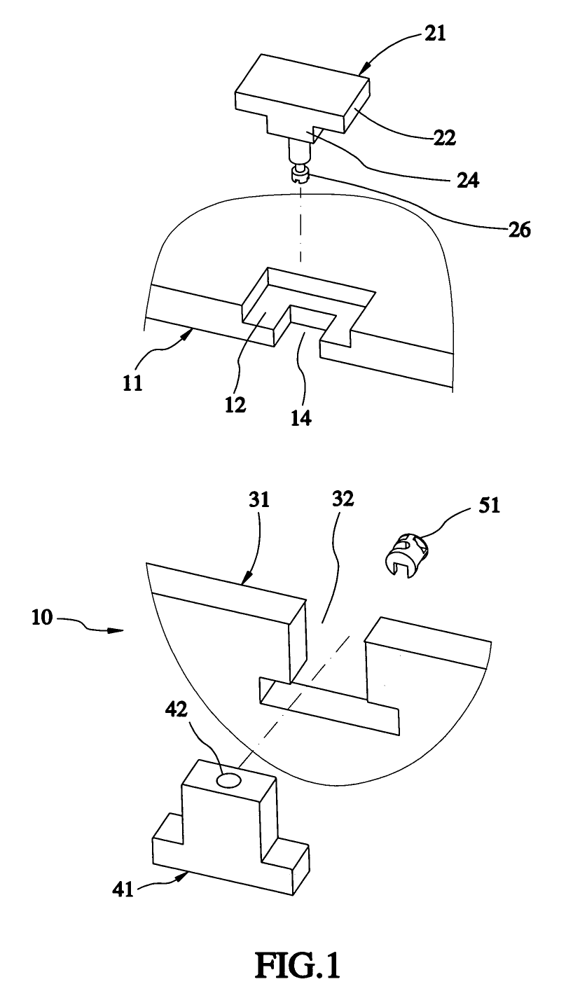

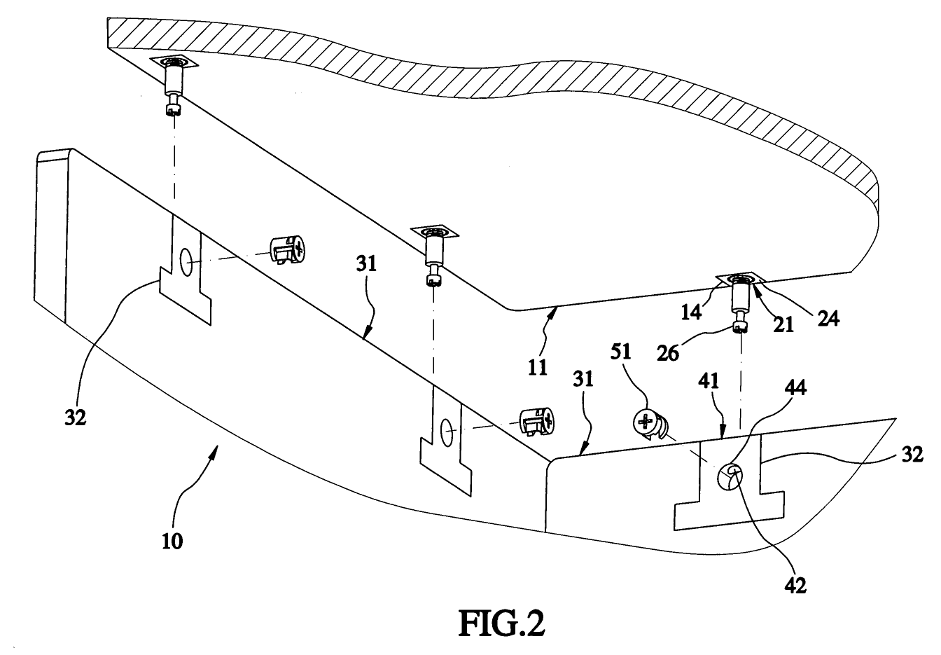

Referring to FIGS. 1 and 2, a board member mounting structure 10 in accordance with the present invention is shown comprising a first board member 11, a plurality of first fastening members 21, a second board member 31, a plurality of second fastening members 41 and a plurality of connectors 51.

The first board member 11 is prepared from a corrugated board, having at least one, for example, a number of recessed portions 12 and an opening 14 in each recessed portion 12.

The first fastening members 21 are respectively molded from plastics. Each first fastening member 21 has a flat head 22 fitting each recessed portion 12 of the first board member 11, a shoulder 24 located on the bottom side of the flat head 22 and fitting the opening 14 in each recessed portion 12 of the first board member 11, and a bolt 26 downwardly extending from the bottom side of the shoulder 24. According to the present preferred embodiment, the bolt 26 is a screw bolt. The first fastening members 21 are respectively mounted in recessed portions 12 of the first board member 11, keeping the top surface of the respective flat heads 22 in flush with the top surface of the first board member 11 and the respective shoulders 24 fitted into the respective openings 14 in the respective recessed portions 12 of the first board member 11 and the respective bolts 26 suspending below the first board member 11.

The second board member 31 is prepared from a corrugated board, having at least one, for example, a number of locating notches 32 at one border edge thereof. Each locating notch 32 has an inverted-T profile with a relatively wider bottom and a relatively narrower top.

The second fastening members 41 are T-blocks molded from plastics. Each second fastening member 41 has a mounting hole 42 axially extending to one end thereof corresponding to the outer opening of each locating notch 32, and a side hole 44 perpendicularly extending from the bottom side of the mounting hole 42 to one side, namely, the front side of the respective second fastening member 41.

The connectors 51 according to the present preferred embodiment are screw nuts respectively inserted into the side holes 44 of the second fastening members 41 and detachably fastened to the bolts 26 of the first fastening members 21.

The second board member 31 is attached to the first board member 11 at right angles to keep the locating notches 32 thereof in communication with the respective openings 14 in the respective recessed portions 12 of the first board member 11, and the first fastening members 21 are respectively fitted into the recessed portions 12 of the first board member 11 to force the respective bolts 26 into the mounting holes 42 of the second fastening members 41, and the connectors 51 are respectively inserted into the side holes 44 of the second fastening members 41 and fastened to the bolts 26 of the first fastening members 21 respectively, securing the first board member 11 and the second board member 31 firmly together.

By means of the aforesaid arrangement, the first board member 11 and the second board member 31 can be fastened together firmly. Further, the first fastening members 21 and the second fastening members 41 are hard plastic members, having sufficient structural strength for interlocking.

Referring to FIGS. 1 and 2, during installation, install the first fastening members 21 in the first board member 11 and install the second fastening members 41 in the second board member 31 respectively, and then attach the first board member 11 to one border edge of the second board member 31 to force the bolts 26 of the first fastening members 21 into the mounting holes 42 of the second fastening members 41 respectively, and then insert the connectors 51 into the side holes 44 of the second fastening members 41 respectively, and then rotate the connectors 51 to fasten up the respective connectors 51 and the respective bolts 26, and therefore the first board member 11 and the second board member 31 are firmly fastened together.

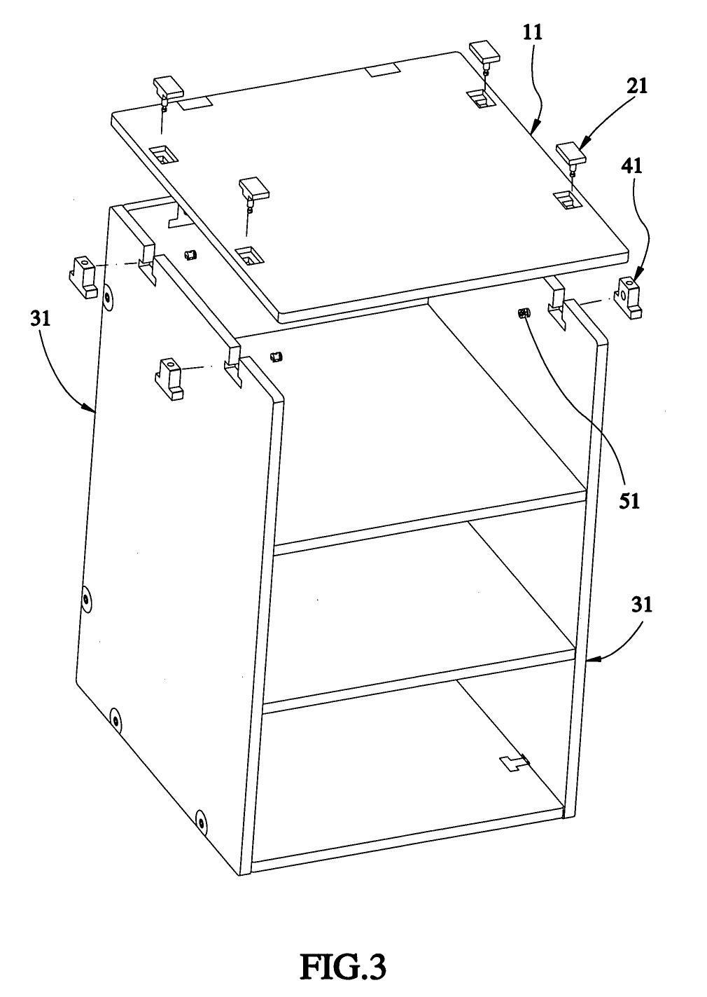

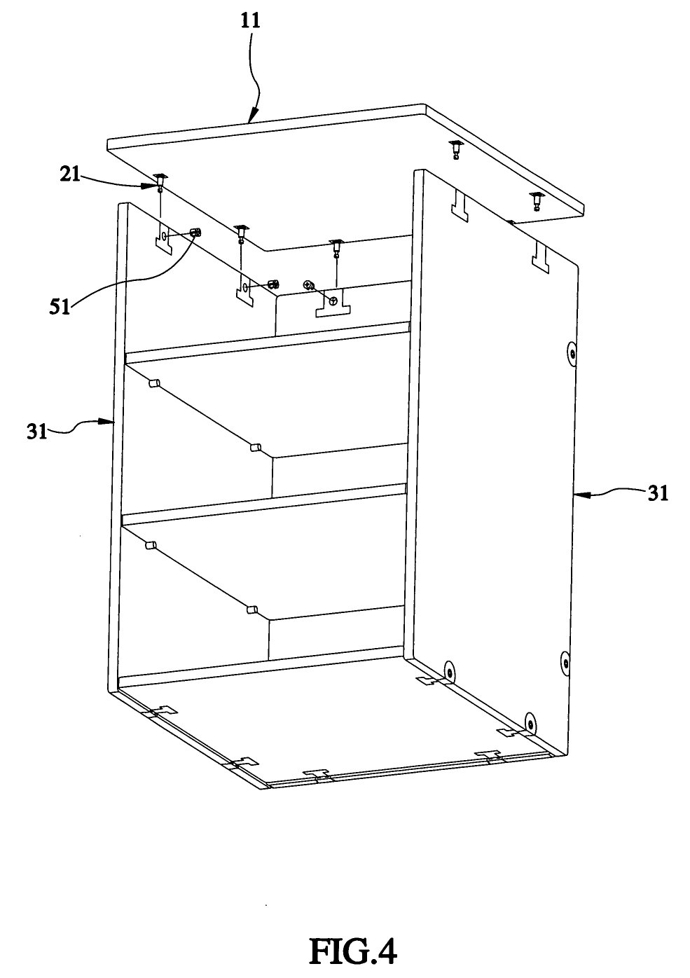

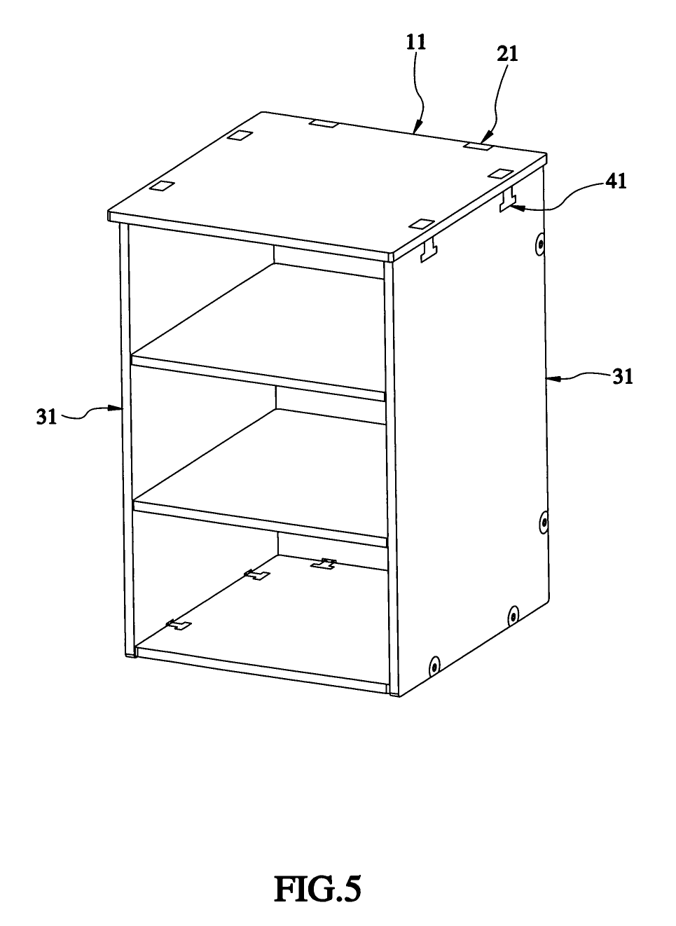

FIGS. 3˜5 show an application example of the present invention. As illustrated, multiple first board members 11 and multiple second board members 31 are fastened together with a number of first fastening members 21, a number of second fastening members 41 and a number of connectors 51 (see FIGS. 3 and 4), forming a multi-compartment cabinet (see FIG. 5).

It is to be understood that the invention is applicable to soft board members as well as hard board members, i.e., the first board member 11 and the second board member 31 can be prepared from corrugated boards as well as wooden boards and other hard board materials.

Further, in actual practice, one board member can be constructed to have the features of the aforesaid first board member as well as the second board member, i.e., one board member can be made having a plurality of recessed portions with an opening in each recessed portion and a plurality of locating notches.

Subject to the design of the present invention, the interlocking stress is distributed through the first fastening members 21 and the second fastening members 41 and then through the contact surface between the first fastening members 21 and the first board member 11 and the contact surface between the second fastening members 41 and the second board member 31, avoiding breaking of the structure. Therefore, soft board materials, for example, paperboards can be used in the present invention.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A board member mounting structure, comprising:
a first board member, said first board member comprising at least one recessed portion and an opening in each said recessed portion;
at least one first fastening members respectively mounted in said at least one recessed portion of said first board member, each said first fastening member comprising a flat head attached to one recessed portion of said first board member, a shoulder extended from a bottom side of said flat head and inserted into the opening in the associating recessed portion of said first board member, and a bolt downwardly extending from a bottom side of said shoulder and extending out of said first board member;
a second board member, said second board member comprising at least one locating notch at one border edge thereof, each said locating notch having a relatively wider bottom side and a relatively narrower top side;
at least one second fastening members respectively mounting in said at least one locating notch of said second board member, each said second fastening member having a shape fitting the shape of said at least one locating notch, each said second fastening member having a mounting hole axially extending to one end thereof corresponding to an outer opening of each said locating notch and a side hole perpendicularly extending from a bottom side of said mounting hole to one side of the respective second fastening member; and
at least one connector respectively inserted into the side hole of each said second fastening member and respectively detachably fastened to the bolt of each said first fastening member.

2. The board member mounting structure as claimed in claim 1, wherein each said locating notch has an inverted-T profile, and each said second fastening member has a T-shaped profile fitting the inverted-T profile of each said locating notch.

3. The board member mounting structure as claimed in claim 1, wherein said first board member and said second board member are respectively prepared from a paper material.

4. The board member mounting structure as claimed in claim 1, wherein said first board member and said second board member are respectively prepared from a corrugated board.

5. The board member mounting structure as claimed in claim 1, wherein the bolt of each said first fastening member is a screw bolt, and each said connector is a screw nut.

6. The board member mounting structure as claimed in claim 1, wherein the flat head and shoulder of each said first fastening member respectively fit the shape of each recessed portion of said first board member and the shape of the opening in each recessed portion of said first board member.

7. The board member mounting structure as claimed in claim 1, wherein said at least one first fastening member and said at least one second fastening member are respectively made of plastics.
